(19) United States
(12) Patent Application Publication
(10) Pub. No.: US 2003/0150248 A1
(43) Pub. Date: Aug. 14, 2003

(54) CYLINDRICAL DOOR LOCK

(76) Inventors: Mei Li Wu, Tainan (TW); Kuo Chih Hsia, Tainan (TW); Chie Gau, Tainan (TW); Yi Hsiung Chao, Taoyuan City (TW); Kung Da Huang, Tainan (TW)

Correspondence Address: CHARLES E. BAXLEY, 5th Floor, 59 John Street, New York, NY, 10038, US

(21) Appl. No.: 10/074,800

(22) Filed: Feb. 14, 2002

(51) Int. Cl. E05B 13/10

(52) U.S. Cl. 70/224

(57) ABSTRACT

A cylindrical door lock includes an escutcheon member having a sleeve, a tube rotatably engaged in the sleeve, a knob rotatably secured to the sleeve and having a lock device, a barrel rotatably received in the escutcheon member and having one or more projections for engaging into the tube, an inner knob secured to the barrel, a rod slidably engaged in the inner knob and having two depressions, a spring catch engaged on the barrel and having two legs for selectively engaging with the depressions of the rod and for selectively locking the barrel to the rod.

### BACKGROUND OF THE INVENTION

1. Field of the Invention

The present invention relates to a door lock, and more particularly to a cylindrical door lock.

2. Description of the Prior Art

Various kinds of typical cylindrical door locks have been developed and used for a long time. U.S. Pat. No. 5,040,391 to Lin and U.S. Pat. No. 5,074,607 to Lin disclose two of the typical cylindrical door locks and comprise a complicated actuating configuration that may not be easily manufactured and assembled.

The present invention has arisen to mitigate and/or obviate the afore-described disadvantages of the conventional cylindrical door locks.

### SUMMARY OF THE INVENTION

The primary objective of the present invention is to provide a cylindrical door lock having a simplified configuration for facilitating the manufacturing and assembling of the cylindrical door lock.

In accordance with one aspect of the invention, there is provided a cylindrical door lock for a door comprising an escutcheon member including a chamber, a sleeve having a bore communicating with the chamber of the escutcheon member and having a stop pin extended inward of the bore thereof, a block received in the chamber of the escutcheon member and having a hole and a lateral channel communicating with the hole thereof, a tube including a tubular body rotatably engaged in the bore of the sleeve and the hole of the block, and including a first end having a peripheral bulge rotatably received in the channel of the block and engaged with the block for limiting a sliding movement of the tube relative to the escutcheon member and the block, and including a groove formed in the tubular body for slidably receiving the stop pin and for limiting the tube to slide relative to the sleeve, and the tube including a hole and at least one orifice formed in the first end thereof, the tube being rotatable relative to the sleeve when the stop pin is disengaged from the groove of the tube, a first knob rotatably secured to the sleeve and including a lock device having an actuator extended within the duct, a shank rotatably received in the tube and including a first end having a notch for receiving the actuator and including a second end having an actuator extended outward through the hole of the tube, a barrel including a first end rotatably received in the chamber of the escutcheon member and including a chamber and at least one projection extended from the first end thereof for selectively securing the barrel to the tube, the barrel including an aperture formed in the first end thereof and including an outer peripheral portion having a peripheral recess and two orifices communicating with the peripheral recess thereof, means for biasing the tube toward the barrel to force and engage the projection of the barrel into the orifice of the tube and to secure the barrel to the tube, and to disengage the stop pin of the sleeve from the groove of the tubular body, a second knob secured to the barrel and rotated in concert with the barrel and including an aperture, a rod slidably engaged in the apertures of the inner knob and the barrel and including a first end extended outward of the inner knob and a second end having a pair of depressions and a passage slidably receiving the actuator of the shank, a spring catch engaged in the peripheral recess of the barrel and including two legs engaged through the orifices of the barrel and engaged inward of the chamber of the barrel for selectively locking the barrel to the rod, the rod being rotatable relative to the barrel to disengage the legs of the spring catch from the depressions of the rod when the rod is rotated by the lock device via the shank, a latchbolt slidably engaged through the escutcheon member, and means for coupling the barrel to the latchbolt and to actuate the latchbolt.

The coupling means includes a frame slidably received in the lateral channel of the block and slidable relative to the tube and the barrel, the frame includes a first end having a passage formed therein and includes a post extended in the first end thereof, the coupling means further includes a latch device having the latchbolt slidably engaged therein and extended outward of the latch device, the latchbolt includes at least one hook extended therefrom and slidably engaged through the passage of the frame and hooked to the frame, for allowing the latchbolt to be moved and actuated by the frame, the coupling means further includes a spring member having two ends secured to the first end of the barrel and having a middle portion secured to the post of the frame for allowing the frame and thus the latchbolt to be moved relative to the latch device and the escutcheon member by rotating the barrel.

The barrel includes a pair of opposite flat surfaces formed in the first end thereof, and includes two fasteners securing the two ends of the spring member to the flat surfaces of the barrel.

The second knob includes a conduit extended therefrom and engaged in the chamber of the barrel and secured to the barrel, the rod includes a peripheral rib extended radially outward from the first end thereof and received in the inner knob, for engaging with the inner knob and for preventing the rod from being disengaged from the inner knob.

The escutcheon member includes a first end having the sleeve extended therefrom, and includes a second end, and includes a cover secured to the second end thereof, the barrel includes a peripheral flange extended radially outward from the first end thereof for engaging with the cover, and for rotatably retaining the first end of the barrel in the chamber of the escutcheon member.

Further objectives and advantages of the present invention will become apparent from a careful reading of a detailed description provided hereinbelow, with appropriate reference to accompanying drawings.

### BRIEF DESCRIPTION OF THE DRAWINGS

FIG. 1 is an exploded view of a cylindrical door lock in accordance with the present invention;

FIG. 2 is a cross sectional view taken along lines 2-2 of FIG. 3;

FIG. 3 is a cross sectional view taken along lines 3-3 of FIG. 2;

FIG. 4 is a cross sectional view similar to FIG. 2, illustrating the operation of the cylindrical door lock;

FIG. 5 is a cross sectional view taken along lines 5-5 of FIG. 2;

FIGS. 6, 7 are cross sectional views taken along lines 6-6 and 7-7 of FIG. 4 respectively; and

FIGS. 8, 9 are cross sectional views similar to FIG. 7, illustrating the operation of the cylindrical door lock.

### DETAILED DESCRIPTION OF THE PREFERRED EMBODIMENT

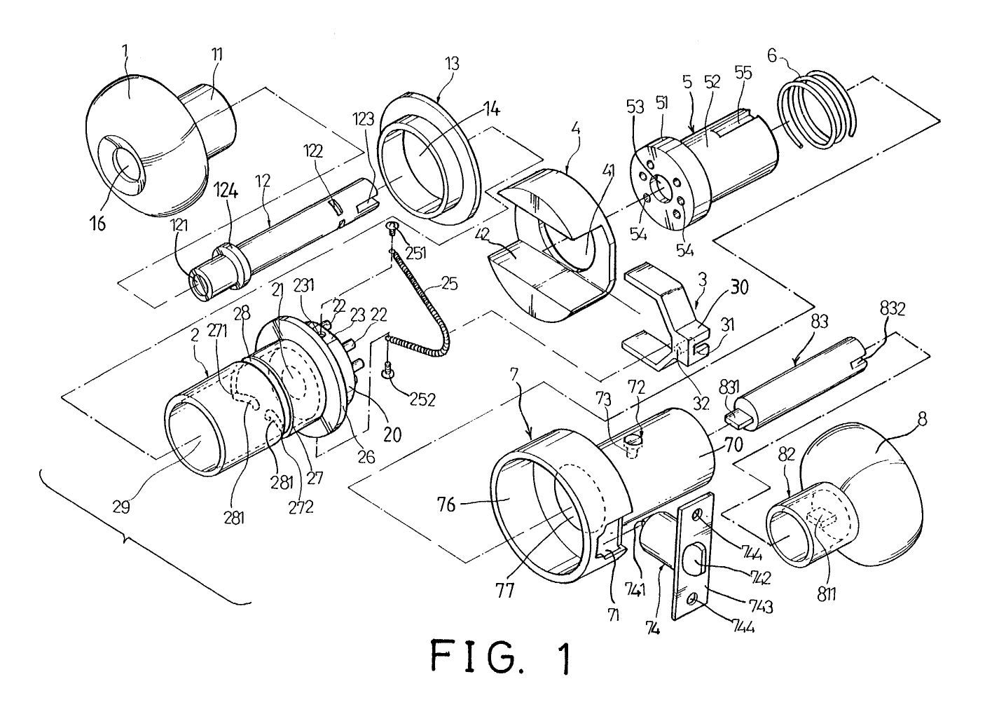

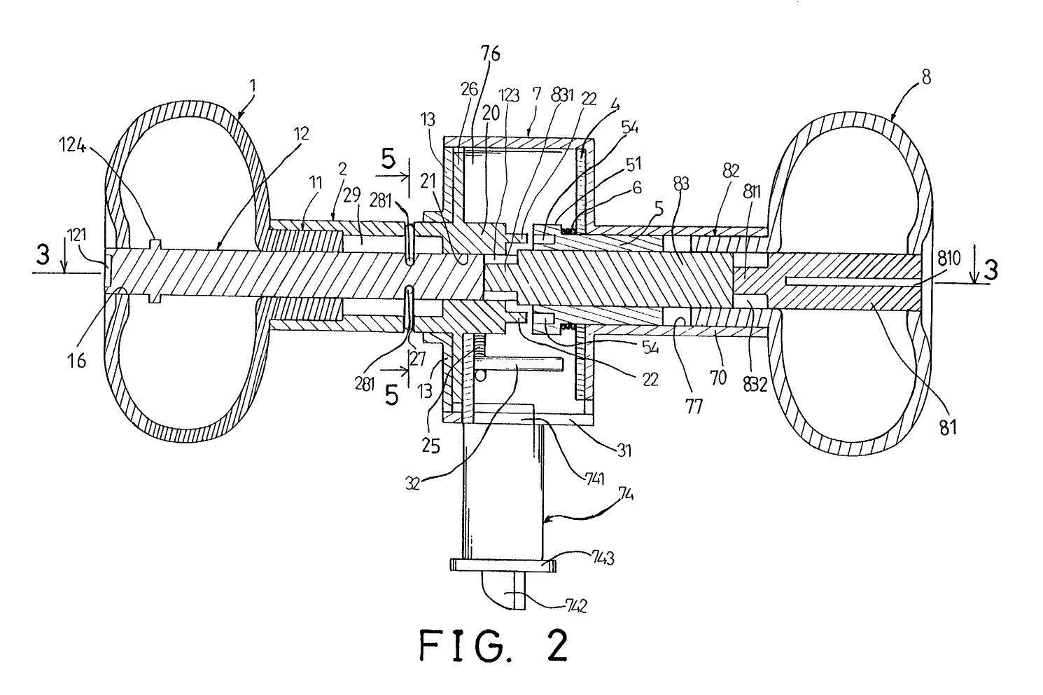

Referring to the drawings, and initially to FIGS. 1 and 2, a cylindrical door lock in accordance with the present invention comprises a rosette member or an escutcheon member 7 to be secured in a door panel (not shown), and including a sleeve 70 extended from one end thereof and having an outer diameter smaller than the escutcheon member 7, and including a chamber 76 formed therein, and including an opening 71 formed in the outer peripheral portion thereof and communicating with the chamber 76 thereof. The sleeve 70 includes a bore 77 formed therein and communicating with the chamber 76 of the escutcheon member 7, and includes a stop pin 73 extended inward of the bore 77 thereof. The stop pin 73 includes EL hole 72 formed therein. A cover 13 is secured in the other end of the escutcheon member 7 with such as the fasteners, the adhesive materials, or by welding processes, and may be formed as an integral-one-piece structure with the escutcheon member 7, and includes an orifice 14 formed therein.

A block 4 is received in the chamber 76 of the escutcheon member 7, and includes a hole 41 formed therein, and includes a lateral channel 42 formed therein and communicating with the hole 41 thereof. A tube 5 includes a tubular body 52 rotatably engaged in the bore 77 of the escutcheon member 7 and the hole 41 of the block 4, and includes a peripheral bulge 51 extended radially outward from one end thereof and rotatably received in the channel 42 of the block 4 and engaged with the block 4 for limiting the sliding movement of the tube 5 relative to the escutcheon member 7 and the block 4. The tube 5 includes a groove 55 formed in the tubular body 52 for slidably receiving the stop pin 73 and for limiting the tube 5 to slide relative to the sleeve 70, and includes a hole 53 formed therein, and includes one or more orifices 54 formed in the one end thereof. The tube 5 is rotatable freely relative to the sleeve 70 when the stop pin 73 is disengaged from the groove 55 of the tube 5.

A knob, such as an outer knob 8 includes a duct 82 rotatably engaged in or rotatably secured in the bore 77 of the sleeve 70, and includes a lock device 81 secured therein and having a key hole 810 formed therein for receiving a correct key (not shown) , and having an actuator 811 extended inward or within the duct 82. A shank 83 is rotatably received in the tube 5, and includes a notch 832 formed in one end thereof for receiving the actuator 811 and for allowing the shank 83 to be rotated and driven by the lock device 81 and/or the outer knob 8. The shank 83 includes an actuator 831 extended from the other end thereof, opposite to the notch 832 thereof, and extended outward through the hole 53 of the tube 5, and thus extended inward of the lateral channel 42 of the block 4 and within the chamber 76 of the escutcheon member 7.

A barrel 2 includes one end 20 rotatably engaged through the orifice 14 of the cover 13 and rotatably received in the chamber 76 of the escutcheon member 7, and includes a peripheral flange 26 extended radially outward from the one end 20 thereof for engaging with the cover 13 and/or with the escutcheon member 7, and for rotatably retaining the one end 20 of the barrel 2 in the chamber 76 of the escutcheon member 7. The barrel 2 includes a chamber 29 formed therein, and includes an aperture 21 formed in the one end 20 thereof and having an inner diameter smaller than that of the chamber 29 of the barrel 2. The barrel 2 includes one or more projections 22 extended from the one end 20 thereof for selectively engaging into the orifices 54 of the tube 5, and for selectively coupling and securing the barrel 2 to the tube 5. A spring 6 may further be provided and engaged between the block 4 or the escutcheon member 7 and the peripheral bulge 51 of the tube 5, for biasing the tube 5 toward the barrel 2, and for forcing the projections 22 of the barrel 2 to engage into the orifices 54 of the tube 5, and for securing the barrel 2 to the tube 5.

Another knob, such as an inner knob 1 includes a conduit 11 extended therefrom and engaged in the chamber 29 of the barrel 2 and secured to one end of the barrel 2 by such as a force-fitted engagement, or by a welding process, or by fasteners, such that the inner knob 1 rotates in concert with the barrel 2, and such that the barrel 2 may be rotated by the inner knob 1. The inner knob 1 includes an aperture 16 formed therein. A rod 12 is slidably engaged in the aperture 16 of the inner knob 1 and the aperture 21 of the barrel 2, and includes one end 121 extended outward of the inner knob 1, and includes a peripheral rib 124 extended radially outward from the one end 121 thereof and received in the inner knob 1, for engaging with the inner knob 1 and for preventing the rod 12 from being disengaged from the inner knob 1. The rod 12 includes a pair of depressions 122 formed in the other end thereof, and further includes a passage 123 formed in the other end thereof for selectively and slidably receiving the actuator 831 of the shank 83.

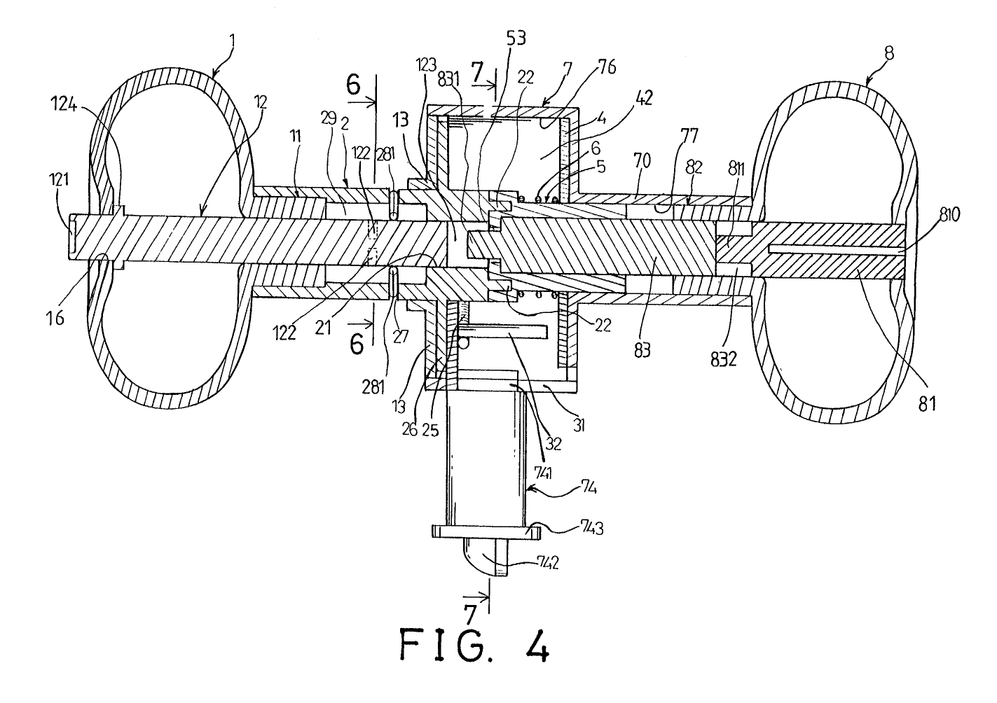

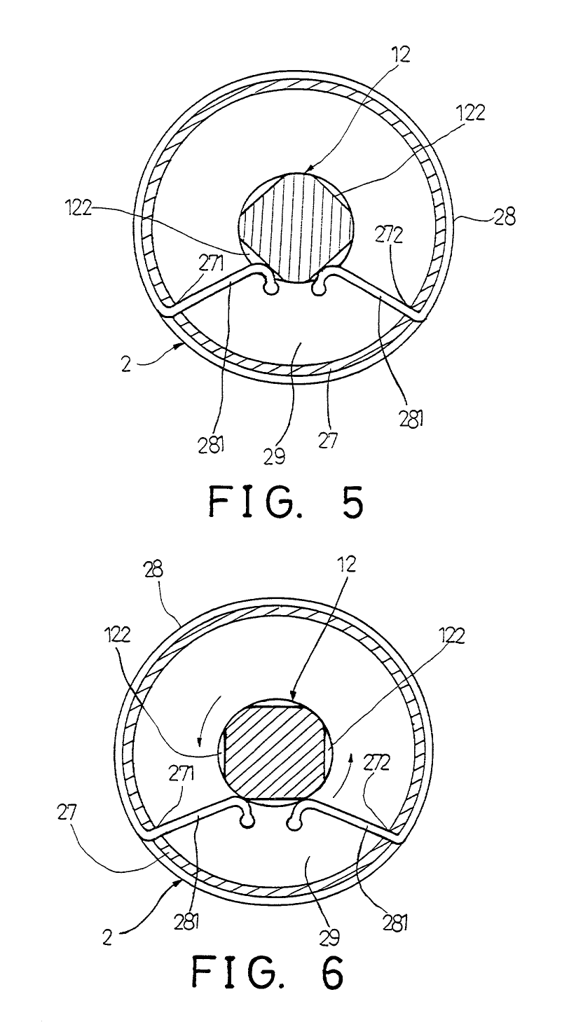

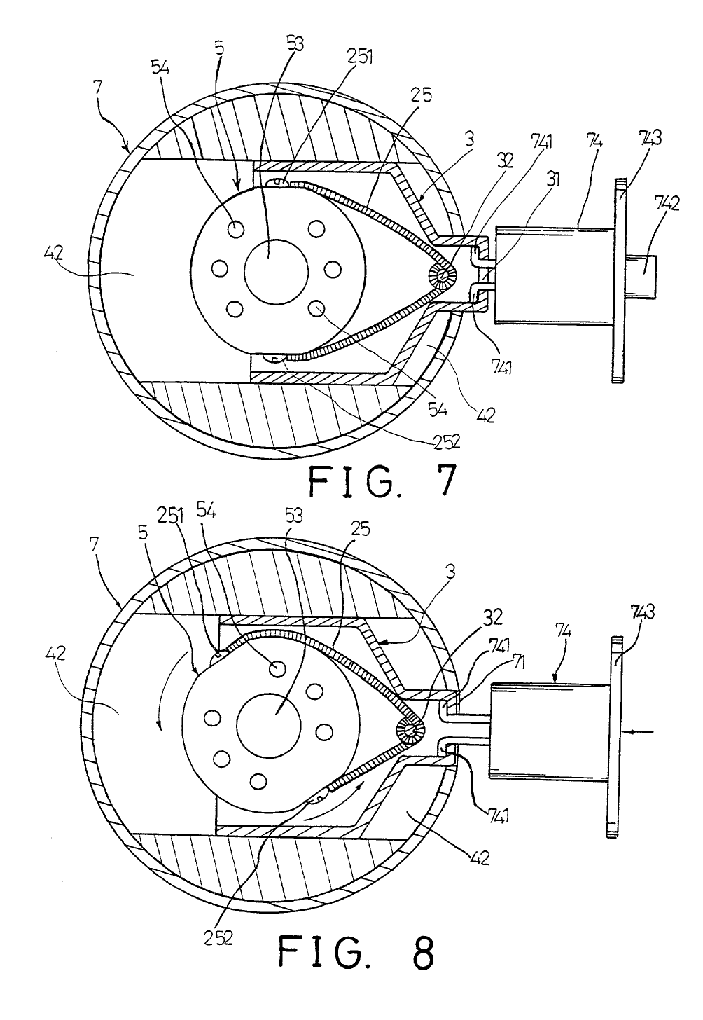

The barrel 2 further includes a peripheral recess 27 formed in the outer peripheral portion thereof, and includes two orifices 271, 272 formed therein and communicating with the peripheral recess 27 thereof. A spring catch 28 is engaged in the peripheral recess 27 of the barrel 2 and includes two legs 281 engaged through the orifices 271, 272 of the barrel 2 and engaged inward of the chamber 29 of the barrel 2, and selectively engaged with the depressions 122 of the rod 12 (FIGS. 2, 3, 5), for selectively catching or locking the barrel 2 to the rod 12. The rod 12 may be rotated relative to the barrel 2 in order to disengage the legs 281 of the spring catch 28 from the depressions 122 of the rod 12 (FIGS. 4, 6), when the rod 12 is rotated by the lock device 81 via the shank 83 and when the key is engaged into the key hole 810 of the lock device 81.

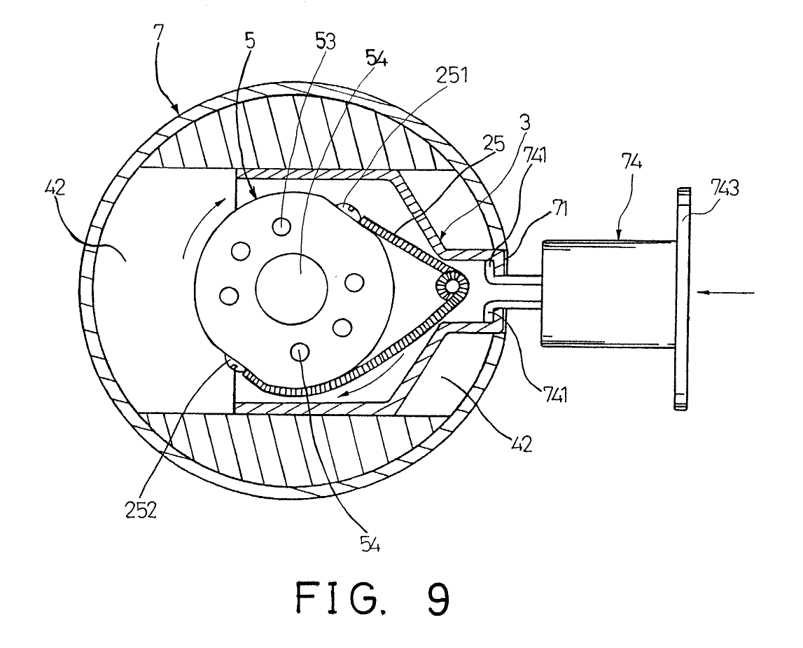

As shown in FIGS. 1 and 7-9, a frame 3 is slidably received in the lateral channel 42 of the block 4, and slidable relative to the tube 5 and the barrel 2, and includes a passage 31 formed in one end 30 thereof, and includes a post 32 extended in the one end 30 thereof. A latch device 74 is also to be secured in a door panel (not shown), and includes a plate 743 having two holes 744 for securing to the door panel, and includes a latchbolt 742 slidably engaged therein and extended outward of the latch device 74 for engaging with a jamb (not shown). The latchbolt 742 includes one or more hooks 741 extended therefrom and slidably engaged through the passage 31 of the frame 3 and hooked to the frame 3, and for allowing the latchbolt 742 to be moved or actuated by the frame 3.

The barrel 2 includes a pair of opposite flat surfaces 23 formed in the one end 20 thereof, and a pair of screw holes 231 formed in the flat surfaces 23 thereof respectively. A spring member 25 includes two ends secured to the one end 20, such as the flat surfaces 23 of the barrel 2 with fasteners 251, 252 which are threaded to the screw holes 231 of the barrel 2, and includes a middle portion engaged around or secured to the post 32 of the frame 3. The frame 3 and thus the latchbolt 742 may be moved relative to the latch device 74 and the escutcheon member 7 (FIGS. 7-9), by rotating the barrel 2, in order to move the latchbolt 742 relative to the latch device 74 and in order to unlock the latchbolt 742 from the jamb.

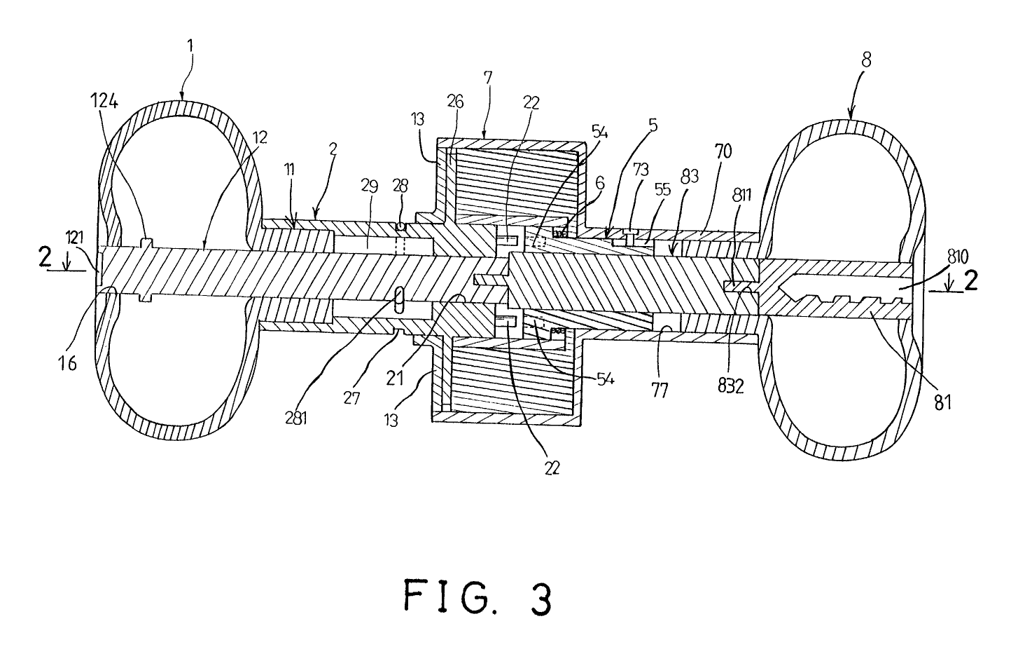

In operation, as shown in FIGS. 2 and 3, the rod 12 may be depressed inward of the inner knob 1, and the legs 281 of the spring catch 28 may be engaged into the depressions 122 of the rod 12 (FIGS. 2, 3, 5) in order to lock the rod 12 to the barrel 2. Simultaneously, when the rod 12 is depressed inward of the inner knob 1, the rod 12 may be secured to the shank 83 by the engagement of the actuator 831 of the shank 83 in the passage 123 of the rod 12, and may thus be locked in place by the lock device 81. The tube 5 may also be depressed inward of the bore 77 of the sleeve 70 against the spring 6, and the stop pin 73 may be engaged into the groove 55 of the tube 5, in order to lock the tube 5 to the escutcheon member 7.

When the correct key is engaged into the key hole 810 of the lock device 81 and is rotated or actuated to unlock and to rotate the rod 12 by the shank 83, the depressions 122 of the rod 12 may be rotated and disengaged from the legs 281 of the spring catch 28, or relatively, the legs 281 of the spring catch 28 may be disengaged from the depressions 122 of the rod 12, such that the rod 12 may be disengaged or released or unlocked from the barrel 2.

It is to be noted that the present invention is to provide the spring catch 28 having the legs 281 for engaging into the depressions 122 of the rod 12, and for locking the rod 12 to the barrel 2, and to provide a frame 3 slidably received in the lateral channel 42 of the block 4, and a spring 25 for coupling the barrel 2 to the frame 3 and thus the latchbolt 742.

Accordingly, the cylindrical door lock in accordance with the present invention includes a simplified configuration for facilitating the manufacturing and assembling of the cylindrical door lock.

Although this invention has been described with a certain degree of particularity, it is to be understood that the present disclosure has been made by way of example only and that numerous changes in the detailed construction and the combination and arrangement of parts may be resorted to without departing from the spirit and scope of the invention as hereinafter claimed.

I claim:

1. A cylindrical door lock for a door, said door lock comprising:
an escutcheon member for securing to the door, said escutcheon member including a chamber formed therein, and including a sleeve extended therefrom and having a bore formed therein and communicating with said chamber of said escutcheon member and having a stop pin extended inward of said bore thereof,
a block received in said chamber of said escutcheon member, and including a hole formed therein, and including a lateral channel formed therein and communicating with said hole thereof,
a tube including a tubular body rotatably engaged in said bore of said sleeve and said hole of said block, and including a first end having a peripheral bulge extended radially outward therefrom and rotatably received in said channel of said block and engaged with said block for limiting a sliding movement of said tube relative to said escutcheon member and said block, said tube including a groove formed in said tubular body for selectively and slidably receiving said stop pin and for limiting said tube to slide relative to said sleeve, and said tube including a hole formed therein and at least one orifice formed in said first end thereof, said tube being rotatable relative to said sleeve when said stop pin is disengaged from said groove of said tube,
a first knob rotatably secured to said sleeve, and including a lock device secured therein and having an actuator extended within said duct,
a shank rotatably received in said tube, and including a first end having a notch formed therein for receiving said actuator and for allowing said shank to be rotated and driven by said lock device and said outer knob, said shank including a second end having an actuator extended therefrom and extended outward through said hole of said tube,
a barrel including a first end rotatably received in said chamber of said escutcheon member, and including a chamber formed therein, and including at least one projection extended from said first end thereof for selectively engaging into said at least one orifice of said tube and for selectively securing said barrel to said tube, said barrel including an aperture formed in said first end thereof, said barrel including an outer peripheral portion having a peripheral recess formed therein, and including two orifices formed therein and communicating with said peripheral recess thereof,
means for biasing said tube toward said barrel to force and engage said at least one projection of said barrel into said at least one orifice of said tube and to secure said barrel to said tube, and to disengage said stop pin of said sleeve from said groove of said tubular body,
a second knob secured to said barrel and rotated in concert with said barrel and including an aperture formed therein,
a rod slidably engaged in said aperture of said second knob and said aperture of said barrel, and including a first end extended outward of said second knob, and including a second end having a pair of depressions formed therein and having a passage formed therein for slidably receiving said actuator of said shank,
a spring catch engaged in said peripheral recess of said barrel and including two legs engaged through said orifices of said barrel and engaged inward of said chamber of said barrel for selectively engaging with said depressions of said rod and for selectively locking said barrel to said rod, said rod being rotatable relative to said barrel to disengage said legs of said spring catch from said depressions of said rod when said rod is rotated by said lock device via said shank,
a latchbolt slidably engaged through said escutcheon member, and
means for coupling said barrel to said latchbolt and to actuate said latchbolt.

2. The cylindrical door lock according to claim 1, wherein said coupling means includes a frame slidably received in said lateral channel of said block and slidable relative to said tube and said barrel, said frame includes a first end having a passage formed therein and includes a post extended in said first end thereof, said coupling means further includes a latch device having said latchbolt slidably engaged therein and extended outward of said latch device, said latchbolt includes at least one hook extended therefrom and slidably engaged through said passage of said frame and hooked to said frame, for allowing said latchbolt to be moved and actuated by said frame, said coupling means further includes a spring member having two ends secured to said first end of said barrel and having a middle portion secured to said post of said frame for allowing said frame and thus said latchbolt to be moved relative to said latch device and said escutcheon member by rotating said barrel.

3. The cylindrical door lock according to claim 2, wherein said barrel includes a pair of opposite flat surfaces formed in said first end thereof, and includes two fasteners securing said two ends of said spring member to said flat surfaces of said barrel.

4. The cylindrical door lock according to claim 1, wherein said second knob includes a conduit extended therefrom and engaged in said chamber of said barrel and secured to said barrel, said rod includes a peripheral rib extended radially outward from said first end thereof and received in said second knob, for engaging with said second knob and for preventing said rod from being disengaged from said second knob.

5. The cylindrical door lock according to claim 1, wherein said escutcheon member includes a first end having said sleeve extended therefrom, and includes a second end, and includes a cover secured to said second end thereof, said barrel includes a peripheral flange extended radially outward from said first end thereof for engaging with said cover, and for rotatably retaining said first end of said barrel in said chamber of said escutcheon member.
